(19) United States
(12) Patent Application Publication
(10) Pub. No.: US 2006/0287786 A1
(43) Pub. Date: Dec. 21, 2006

(54) Recorded communication system for aircraft

(76) Inventor: Jesse A. Todd, Sanford, NC (US)

Correspondence Address: SIEBERTH & PATTY, LLC, 4703 BLUEBONNET BLVD, BATON ROUGE, LA, 70809, US

(21) Appl. No.: 10/557,942

(22) PCT Filed: May 21, 2004
(86) PCT No.: PCT/US04/16048

§ 371 Date: Nov. 21, 2005

Related U.S. Application Data
(60) Provisional application No. 60/472,292, filed on May 21, 2003.

(51) Int. Cl. G01M 17/00

(52) U.S. Cl. 701/35

(57) ABSTRACT

An aviation communication system which includes (a) a recording device in operative connection with (i) a communication signal transceiver so as to enable the recording of communication signals sent and received by the transceiver and so as to enable the generation of an audio signal output, and (ii) an audio transmitter for converting the audio signal output from the recording device into audible sound; and (b) a controller configured for operative connection to the recording device, which controller enables one or more recorded communication signals from the recording device to be transmitted as one or more audio signals to the audio transmitter while the recording device continues to record communication signals sent and received by the transceiver. In one embodiment, the system provides indexing of the recorded signals to enable facile reference back to previously recorded communication signals to facilitate effective communication with other pilots and air traffic controllers during flight under challenging circumstances. Related methods of conducting avionic communications are also provided.

### FIELD OF THE INVENTION

The present invention pertains to aviation communication systems.

### BACKGROUND

The primary means of interaction between pilots and air traffic controllers is radio communication on increasingly crowded frequencies. In high traffic areas such as the Northeast corridor of the United States of America and major airline hubs across the globe, this congestion creates several problems. Transmissions by controllers are given at a more rapid pace, often consisting of multiple instructions involving a series of numbers. It is possible to quickly and correctly read back or recall these instructions using short-term memory, but intervening distractions from normal cockpit duties can result in anything from a simple loss of confidence in the clearance, to inadvertently transposing numbers, to a complete memory loss. The corrective action is to make another transmission to request a clarification, which further aggravates the frequency congestion. Sometimes it may be difficult to get in on a crowded frequency to receive a timely clarification. This further increases the controller's workload, as he may have to resolve a resulting traffic conflict or a disruption in planned traffic flow. Radio communication is arguably one of the weakest links in the air traffic control function, but the human interaction is an essential element in managing such a fluid environment.

Thus, a need continues to exist for communications systems which improve the reliability and efficiency of air traffic communications between pilots and between air traffic controllers and pilots.

### SUMMARY OF THE INVENTION

The present invention satisfies this need, amongst others, in a unique way by providing, in one embodiment, an aviation communication system comprised of (a) a recording device configured for (i) operative connection with a communication signal transceiver for recording communication signals sent and received by the transceiver, and (ii)operative connection with a speaker for converting audio signals from the recording device into audible sound, and (b) a controller configured for operative connection with the recording device, which controller enables selected, recorded audio signals from the recording device to be transmitted to the speaker while the recording device continues to record communication signals sent and received by the transceiver. The communication signals being recorded are typically radio frequency signals, but conceivably could be other signals employed for communication purposes.

In another embodiment, this invention provides a recording device configured to substantially continuously receive and record communications in the form of input/output (i.e., either input or output or both) from an aircraft's active transceiver, which recording device is further configured to enable selective playback of previously recorded communications through a selectable and controllable audio channel, while continuing to record communications in the form of input/output from the active transceiver. In this context, audio channel means a means for delivering audio signals from one point to another, in which an audio waveform submitted to the audio channel input results in a similar or identical waveform at the channel output, where the audio channel may be comprised of some or all of the following components: encoders (compressors) and decoders (decompressors), buffers, multiplexors and demultiplexors, modulators and demodulators, transmission facilities, switches, multipoint conference units, and other components necessary to achieve the desired channel characteristics.

Yet another embodiment of this invention provides a method of conducting in-flight audio signal communications between a pilot of a first airplane and either an air traffic controller or another pilot of at least a second airplane, the method comprising recording the communication signal transmissions sent and received by an on-board communication signal transceiver of the first airplane during flight, while concurrently outputting from the recording device at least one previously recorded communication signal as an audio signal output to an on-board audio transmitter to thereby produce an audible sound.

These and other embodiments, features and attributes of the present invention will now become more apparent from the ensuing description, including the appended drawings and accompanying claims.

### SUMMARY OF THE DRAWINGS

FIG. 1 is a schematic illustration of one system of this invention.

FIG. 2 is a schematic illustration of another system of this invention integral with an audio panel.

FIG. 3 is a schematic illustration of another system of this invention integral with a remote tuning unit.

FIG. 4 is a schematic illustration of another system of this invention integral with a flight management system.

Like reference numbers or reference letters in the figures are used to refer to like components amongst the several figures.

### DETAILED DESCRIPTION OF PREFERRED EMBODIMENTS

The present invention overcomes the problems of current aviation communications systems by providing a recording capability, and preferably one which is digital, for aircraft radio communication equipment that allows for instant playback of previously recorded communication transmissions, while continuing to record ongoing received transmissions.

In one embodiment, the user interface with the recording allows the pilot or co-pilot to quickly locate and replay the desired section of recorded communications. This is accomplished in one embodiment of the invention by placing a “bookmark” (i.e., by indexing the recording so as to place a periodic or pre-selected point in the previously recorded sequence of signals or data which can be found and returned to for playback by the recording device) in the recording at particular time in the recording sequence based upon the occurrence of a pre-selected event. Examples of suitable pre-selected events could include the actuation of a microphone to initiate a radio transmission to the ground or another airplane, reception of a transmission above a pre-selected squelch setting, the passage of a predetermined amount of time, the completion of certain travel distance determined for example by an airplane navigation system, and the like.

For instance, the bookmarks may be placed in the recording each time the user, e.g., a pilot, keys or actuates a microphone to communicate a message through the transceiver. Alternatively, bookmarks may be placed in the recordings at specific time intervals independent of whether the user has keyed a microphone. The former is preferred in some instances since it allows the user to return to the time in the recording sequence when the user last keyed the microphone. Whichever step is used for placing the bookmarks, each bookmark will mark a location in the recording sequence that can later be revisited to hear the recorded sequence associated in time with a particular bookmark. For example, in one embodiment of the invention, pressing a “Playback Button” on the unit would immediately re-play from a pre-set (adjustable) time interval prior to (or following) the last bookmark, enabling the pilot to quickly and easily re-hear the clearance or other prior communications without having to request a clarification from the controller or other transmitter of the message in question. This capability will facilitate a decrease in frequency congestion, will decrease controller workload, and will increase crew confidence in their ability to comply with clearances and act on other important, previously received information in times of high cockpit workload, all without interrupting the recording of on-going communications. The systems of this invention also reduce system dependence upon the accuracy of pilot memory.

In another embodiment of this invention, the system may only require a “Playback” and “Stop” button or switch, with repeated activation of the Playback button cycling backwards through bookmarks, and activating the Stop button causing resumption of normal communications. A more sophisticated embodiment of this invention could provide a system which graphical user interfaces through menu items on computerized flight management systems or radio control units. These systems could provide any number of other options consistent with recording devices, such as functions including reverse, forward, pause, stop, and erase; along with a visual presentation of existing bookmarks, indicating the time each bookmark was placed and the frequency in use. Such options would allow the user to see how long it has been since the last transmission, alerting him to the possibility of a missed frequency change, or allow the user to quickly return to a previous frequency in the event of an errant frequency change.

Systems of this invention can be easily and inexpensively adaptable to existing aircraft communications equipment. The resultant ability to replace or supplement a fragile human memory with a recording of received clearances and other communications from the ground or other aircraft enhances overall safety of aircraft operations and facilitates the efficient flow of air traffic.

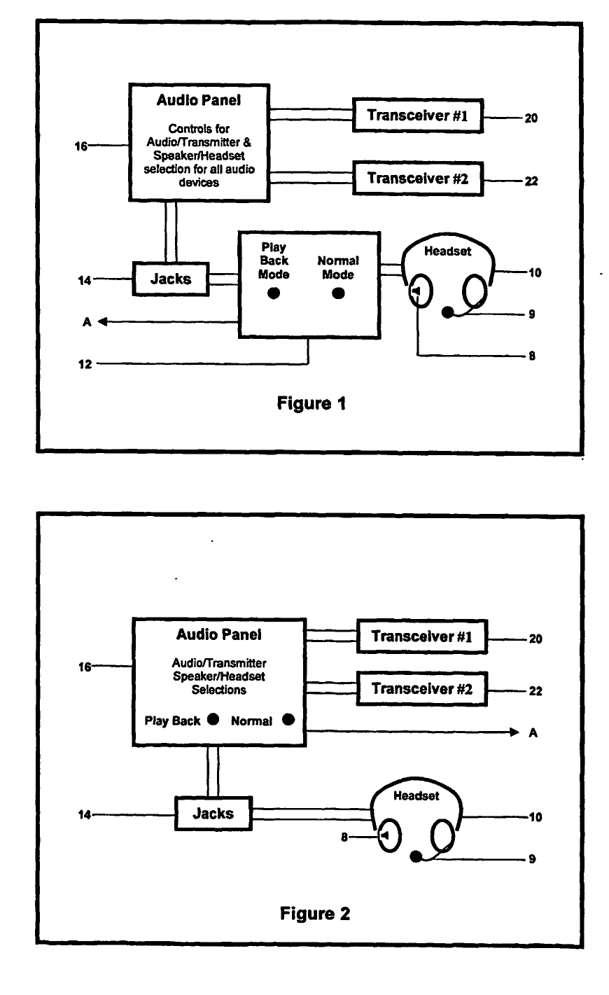

Turning now to the figures, FIG. 1 illustrates schematically one embodiment of the present invention. The system depicted is comprised of an audio transmitter in the form of a headset 10, which includes headset speakers 8 and a microphone 9, in operative connection with the recording device 12. Device 12 includes a switch to control whether device 12 is in a play back mode or a normal (recording) mode, and would of course typically have other controls (not depicted) for powering the device on or off and for controlling volume. Device 12 is in operative connection with audio panel 16 through jacks 14. Transceivers 20 and 22 are operatively connected to panel 16, so that radio frequency communication signals may be sent as output from and/or received as input to audio panel 16, which controls the audio and transmitter selections as well as the connected headset speaker selections. Device 12 substantially continuously records, meaning that it records during flight with only minor operation interruptions for service to replace recording media, other parts or power supplies, or for similar in-flight servicing on an as-needed basis. The playback switch of device 12 enables selective playback of previously recorded communications through a selectable and controllable audio channel, while continuing to record communications in the form of input/output from the transceivers 20 and 22.

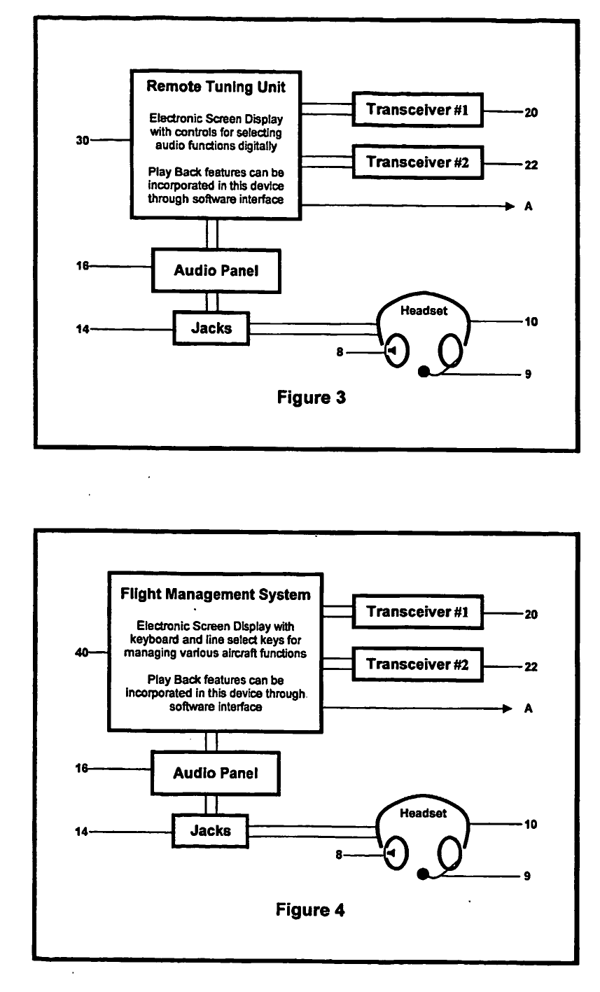

In another embodiment of the invention illustrated in FIG. 2, the functions of the recording device from FIG. 1 are integral with audio panel 16. FIG. 3 illustrates yet another alternative embodiment in which the functions of the recording device from FIG. 1 are integral with a remote tuning unit 30. Still another alternative embodiment illustrated in FIG. 4 incorporates the functions and features of the recording device of FIG. 1 into a flight management system 40. In both FIGS. 3 and 4, the playback controls of the recording device are incorporated into the remote tuning unit or the flight management system, respectively, and may be accessed and operated through a software interface.

It should be appreciated that the recording device illustrated here has integrated with it the controller for operating playback of the recorded communications, but that the recording device and the controller could also be separate units which are not integral with one another. Likewise, the number of transceivers may vary from system to system. In addition, the data recorded by the recording device could be recorded on media with various attributes. For example, in one embodiment of this invention, the memory employed is a large block of contiguous random access memory (or similar) that will record in a linear fashion until consumed, and then start again at the beginning in a continual loop. Bookmarks and associated data preferably would be stored in a separate memory location with references to the appropriate memory address in the continual loop. Playback preferably will be accomplished by reading back data beginning at the memory location referenced by the selected bookmark. All such alternative configurations and recording media, as well as others which should be apparent to those of ordinary skill in the art in view of the foregoing disclosure, are within the scope of the present invention.

In another embodiment of the present invention, a system of this invention is configured to send an electrical output signal representative of bookmark or “click” occurrences during transmission of verbal communications to other navigation devices, such as, e.g., the navigational unit or a moving map display, in order to provide additional data useful in flight navigation. An exemplary representation of such an output signal A is shown in the figures. Typically this signal should be generated by the controller in coordination with the indexing of the recording made by the recording device. The output signal can assist in providing additional data if correlated in time with other data generated by on-board systems. For example, the output signal may be correlated in time with positional data to indicate the position of the airplane at the time the microphone “click” occurred to initiate a radio transmission, or at the time the associated bookmark was recorded in the recording device of the system of this invention. The resulting positional data then may be displayed on a moving map display or other on-board navigational device to permit pilots to determine quickly where and when the last communication with another party occurred. Such a feature also enables the pilot to determine if communications occurred at a particular geographical point, which is sometimes required in air traffic control.

It will now be appreciated by those of skill in this technical field that the implementation of systems in accordance with this invention would involve the use of conventional integrated communications and signal recording and processing equipment and electronics components, and where necessary or desirable digital/analog conversion electronics components. For hand-held versions of the recording device, it is envisioned that the device could be sized and configured to be hand-held, and could in fact be integrated with a personal digital assistant (PDA) or similar hand-held device, with appropriate input and output jacks or transmitters to operatively connect with on-board communications equipment.

The indexing function described herein for use in conjunction with the recording of communications signals could be implemented in a number of ways apparent to those of skill in this field. For example, the indexing could be implemented through software or circuitry configured to insert a data string indicative of the index bookmark in a recorded signal feed at each passage of a pre-selected amount of time (or other event) using an internal or on-board clock, navigation system or similar device capable of monitoring and signally the occurrence of a pre-selected event. Likewise, the configuration of a controller to enable playback of recorded signals while concurrently recording on-going communications could be provided through conventional signal recording devices configured with separate recording and playback functions, implemented either through conventional circuit design or software specifically configured, for example, to temporarily store during playback on-going communications in temporary memory for later storage on the recording media. The particular components employed to configure a system according to this invention should be readily apparent to those of skill in the art having the benefit of this disclosure.

As previously noted, the present invention also provides a method of conducting in-flight audio signal communications between a pilot of a first airplane and either an air traffic controller or another pilot of at least a second airplane. The method comprising recording the communication signal transmissions sent and received by an on-board communication signal transceiver of the first airplane during flight, while concurrently generating an audio output signal from the recording device derived from at least one previously recorded communication signal and transmitting the audio output signal to an on-board audio transmitter to thereby produce an audible sound. The step of recording is preferably carried out by operating a recording device as previously described. The step of generating an audio output signal from the recording device likewise is preferably carried out by converting the recorded signals into the audio output signal which is subsequently transmitted to the audio signal transmitter on-board the first airplane.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent, patent application and printed publication referred to above is incorporated herein by reference in toto to the fullest extent permitted as a matter of law.

This invention is susceptible to considerable variation in its practice. Therefore, the foregoing description is not intended to limit and should not be construed as limiting, the invention to the particular exemplifications presented hereinabove. Rather, what is intended to be covered is as set forth in the ensuing claims and the equivalents thereof permitted as a matter of law.

1. An aviation communication system comprised of
a) a recording device in operative connection with (i) a communication signal transceiver so as to enable the recording of communication signals sent and received by the transceiver and so as to enable the generation of an audio signal output, and (ii) an audio transmitter for converting the audio signal output from the recording device into audible sound, and
b) a controller configured for operative connection to the recording device, which controller enables one or more recorded communication signals from the recording device to be transmitted as one or more audio signals to the audio transmitter while the recording device continues to record communication signals sent and received by the transceiver.

2. An aviation communication system according to claim 1, wherein the recording device is configured to index the recorded communication signals based upon each occurrence of a pre-selected event, so that recorded communication signals associated in time with an occurrence of the pre-selected event may be selectively transmitted to the audio transmitter as audio signal output.

3. An aviation communication system according to claim 2, wherein the pre-selected event is the receipt of a signal indicative of the activation of an on-board microphone to initiate a communication transmission to either the the air traffic controller or the other pilot of the second plane.

4. An aviation communication system according to claim 2, wherein the pre-selected event is the initiation of a transmission received above a pre-selected squelch setting.

5. A aviation communication system according to claim 2, wherein the system is configured to generate an output signal with each occurrence of the pre-selected event, the output signal being susceptible to further processing to provide additional flight information.

6. An aviation communication system according to claim 1 wherein the audio transmitter comprises one or more headset speakers.

7. A recording device configured to substantially continuously receive and record communications in the form of input/output from an aircraft's active transceiver, which recording device is further configured to enable selective playback of previously recorded communications through a selectable and controllable audio channel, while continuing to record communications in the form of input/output from the active transceiver.

8. A recording device according to claim 7, wherein the recording device is sized and further configured to be hand-held.

9. A recording device according to claim 7, wherein the recording device is further configured to index the recorded communications based upon each occurrence of a pre-selected event, so as to enable selective playback of recorded communications associated in time with an occurrence of the pre-selected event.

10. A recording device according to claim 9, wherein the pre-selected event is the receipt of a signal indicative of the activation of an on-board microphone to initiate a communication transmission to either the the air traffic controller or the other pilot of the second plane.

11. A recording device according to claim 10, wherein the recording device is sized and configured to be hand-held.

12. A method of conducting in-flight audio signal communications between a pilot of a first airplane and either an air traffic controller or another pilot of at least a second airplane, the method comprising recording the communication signal transmissions sent and received by an on-board communication signal transceiver of the first airplane during flight, while concurrently outputting from the recording device at least one previously recorded communication signal as an audio signal output to an on-board audio transmitter to thereby produce an audible sound.

13. A method according to claim 12, further comprising indexing the recorded communication signal transmissions based upon each occurrence of a pre-selected event so as to provide one or more reference points in the recording for later use in transmitting from the recording device to the on-board audio transmitter as audio signal output recorded transmissions associated in time with at least one of the one or more reference points.

14. A method according to claim 13 wherein the pre-selected event is the receipt of a signal indicative of the activation of an on-board microphone to initiate a communication transmission to either the the air traffic controller or the other pilot of the second plane.

15. A method according to claim 13 wherein the pre-selected event is the reception of a transmission received above a pre-selected squelch setting.

16. A method according to claim 13, further comprising generating an output signal with each occurrence of the pre-selected event, the output signal being susceptible to further processing to provide additional flight information.
